(19) United States
(12) Patent Application Publication
(10) Pub. No.: US 2022/0240738 A1
(43) Pub. Date: Aug. 4, 2022

(54) VACUUM STABILITY BRACKET

(71) Applicant: ShopRover, LLC, Novi, MI (US)

(72) Inventors: Daniel W. King, Copley, OH (US); Michael W. Maurer, Novi, MI (US)

(73) Assignee: ShopRover, LLC, Novi, MI (US)

(21) Appl. No.: 17/585,740

(22) Filed: Jan. 27, 2022

Related U.S. Application Data
(60) Provisional application No. 63/143,263, filed on Jan. 29, 2021.

(51) Int. Cl. A47L 9/00; F16L 3/13; F16L 3/12; A47L 9/24

(52) U.S. Cl. CPC A47L 9/0063; A47L 9/248; F16L 3/1218; F16L 3/13

(57) ABSTRACT

A stability bracket, which may be configured to be attached to a vacuum that has a hose. The stability bracket includes a mating arm defining a flexible region and configured to conform to the vacuum, irrespective of size and/or shape. The stability bracket may be attached via a strap to any size/shape vacuum. The stability bracket includes a bracket arm operatively attached to one side of the mating arm, such that the bracket arm defining a hose gap opposite the attachment side, which is configured to receive the hose into the bracket arm. In some configurations, the bracket arm may be formed integrally with a wheel caster housing operatively attached to a lower housing of the vacuum. This may be referred to as a caster bracket arm, which extends from the wheel caster housing, such that the hose is configured to sit within the caster bracket arm.

### CROSS-REFERENCE TO RELATED APPLICATIONS

This application claims the benefit of U.S. Provisional Application No. 63/143,263, filed Jan. 29, 2021, which is hereby incorporated by reference in its entirety.

### INTRODUCTION

This disclosure generally relates to devices usable for providing stability for a wide variety of wet/dry vacuums, particularly those that roll or slide.

### SUMMARY

A stability bracket, which may be configured to be attached to a vacuum or vacuum assembly that has a hose, is provided. The stability bracket includes a mating arm defining a flexible region. Therefore, the mating arm is configured to conform to the vacuum, irrespective of size and/or shape. The stability bracket includes a bracket arm operatively attached to one side of the mating arm, such that the bracket arm defining a hose installation gap or hose gap opposite the attachment side. The hose gap is configured to receive the hose into the bracket arm.

In some configurations of the stability bracket the bracket arm has a flat upper surface and an angled lower surface, such that the hose has one point of contact, along the lower surface, with the bracket arm. The stability bracket may be configured to be attached to the vacuum via a strap at or below a bottom half of the vacuum, such that pulling on the hose applies a pull force to the bottom half of the vacuum.

Additional features of the stability bracket may include: one or more ribs formed on an interior of the bracket arm, such that the ribs are configured to interlock with the hose and to prevent the hose from sliding within the bracket arm, or one or more anti-slip features attached to the interior of the mating arm to prevent slipping the vacuum.

In some configurations, the bracket arm may be formed integrally with a wheel caster housing that is operatively attached to a lower housing of the vacuum. This may be referred to as a caster bracket arm, which extends from the wheel caster housing, such that the hose is configured to sit within the caster bracket arm.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIG. 1 schematically illustrates an isometric top view of a stability bracket usable with different wet/dry vacuum assemblies.

FIG. 2 schematically illustrates a front view of the stability bracket.

FIG. 3 schematically illustrates another isometric view of the stability bracket.

FIG. 4 schematically illustrates another isometric view of the stability bracket.

FIG. 5 schematically illustrates another isometric view of the stability bracket.

FIG. 6 schematically illustrates another isometric view of the stability bracket.

FIG. 7 schematically illustrates a side view of the stability bracket.

FIG. 8 schematically illustrates a side view of the stability bracket installed on an example vacuum assembly.

FIG. 9 schematically illustrates a bottom view of the stability bracket.

FIGS. 10A and 10B schematically illustrate different vacuum assemblies and configurations, showing hose attachments high on the vacuum assemblies.

FIGS. 11A, 11B, and 11C schematically illustrate the vacuum assembly showing pull forces, moments caused thereby, and resulting tipping.

FIG. 12 schematically illustrates a front view of the stability bracket on the vacuum assembly, showing variable hose positions.

FIG. 13 schematically illustrates a side view of the stability bracket, showing a section cut for FIGS. 14 and 15.

FIG. 14 schematically illustrates a partial section view taken generally along the section line of FIG. 13, showing strap installation relative to the vacuum assembly.

FIG. 15 schematically illustrates a plane intersection view taken generally along the section line of FIG. 13, showing strap grooves in the stability bracket.

FIGS. 16A, 16B, and 16C schematically illustrates the vacuum assembly subject to various example wheel obstructions, including a cord (FIG. 16A), uneven pavement (FIG. 16B), and gravel or pebbles (FIG. 16C).

FIG. 17 schematically illustrates a side view of the stability bracket.

FIG. 18 schematically illustrates a bottom view of the stability bracket showing an example mounting arm flex range.

FIG. 19 schematically illustrates a typical vacuum cleaner hose.

FIG. 20 schematically illustrates a vacuum assembly having a kinked hose.

FIG. 21 schematically illustrates a top view of the stability bracket optional elements, including anti-slip features and an arm closing feature.

FIG. 22 schematically illustrates a back view of the stability bracket with the additional features.

FIG. 23 schematically illustrates an isometric view of a stability bracket integrated as an arm into a caster housing for a vacuum assembly.

FIG. 24 schematically illustrates a top view of the caster housing arm.

FIG. 25 schematically illustrates an isometric view of the caster housing arm.

FIG. 26 schematically illustrates a side view of the caster housing arm.

FIG. 27 schematically illustrates a bottom isometric view of the caster housing arm.

FIG. 28 schematically illustrates another side view of the caster housing arm.

FIG. 29 schematically illustrates another bottom isometric view of the caster housing arm.

FIG. 30 schematically illustrates a front view of the caster housing arm.

FIG. 31 schematically illustrates a bottom view of the caster housing arm.

FIG. 32 schematically illustrates the caster housing arm attached to vacuum assembly with a schematic hose.

FIG. 33 schematically illustrates an isometric view of an optimized stability bracket having similar features to those shown in the previous stability bracket, but with the similar features improved for manufacturing and aesthetic purposes.

FIG. 34 schematically illustrates another isometric view of the optimized stability bracket.

FIG. 35 schematically illustrates another isometric view of the optimized stability bracket.

FIG. 36 schematically illustrates a bottom isometric view of the optimized stability bracket.

FIG. 37 schematically illustrates a front view of the optimized stability bracket.

FIG. 38 schematically illustrates a back view of the optimized stability bracket.

FIG. 39 schematically illustrates a top view of the optimized stability bracket.

FIG. 40 schematically illustrates a bottom view of the optimized stability bracket.

FIG. 41 schematically illustrates a side view of the optimized stability bracket.

FIG. 42 schematically illustrates another side view of the optimized stability bracket.

FIG. 43 schematically illustrates a bottom isometric view of the optimized stability bracket.

FIG. 44 schematically illustrates another bottom isometric view of the optimized stability bracket.

FIG. 45 schematically illustrates a back isometric view of the optimized stability bracket, showing the mounting arm.

FIG. 46 schematically illustrates another back isometric view of the optimized stability bracket, showing the mounting arm.

FIG. 47 schematically illustrates a side view of the stability bracket used to hold a wrapped hose for storage.

### DETAILED DESCRIPTION

Referring to the drawings, like reference numbers correspond to like or similar components, wherever possible, throughout the several figures. All figures may be referred to in any section of the specification, without regard to numerical order, the description regularly refers to more than one figure at a time, and the reference numbers may not be presented in numerical order.

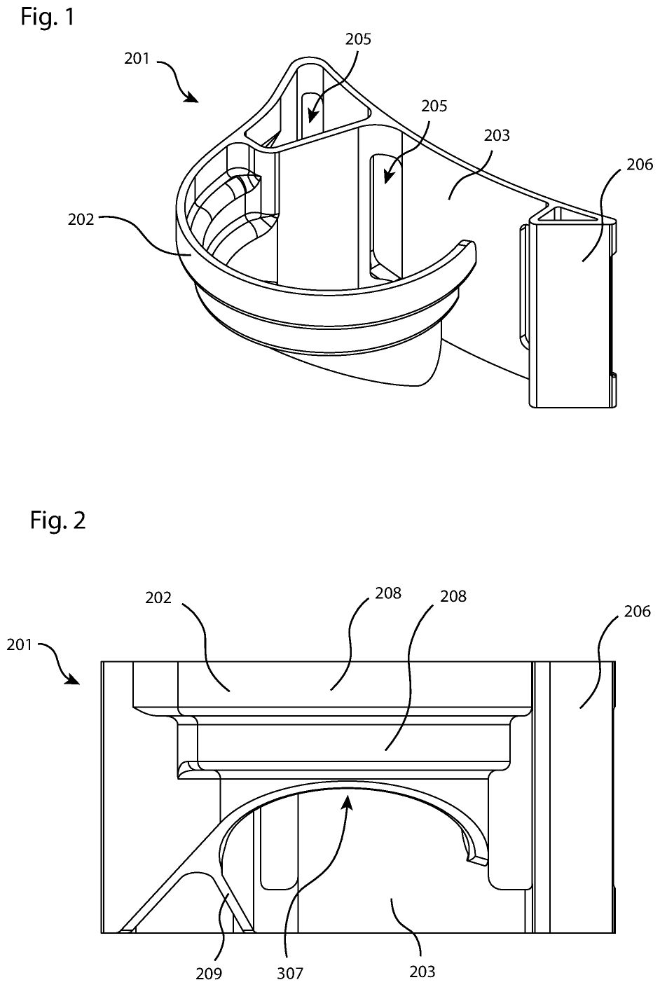

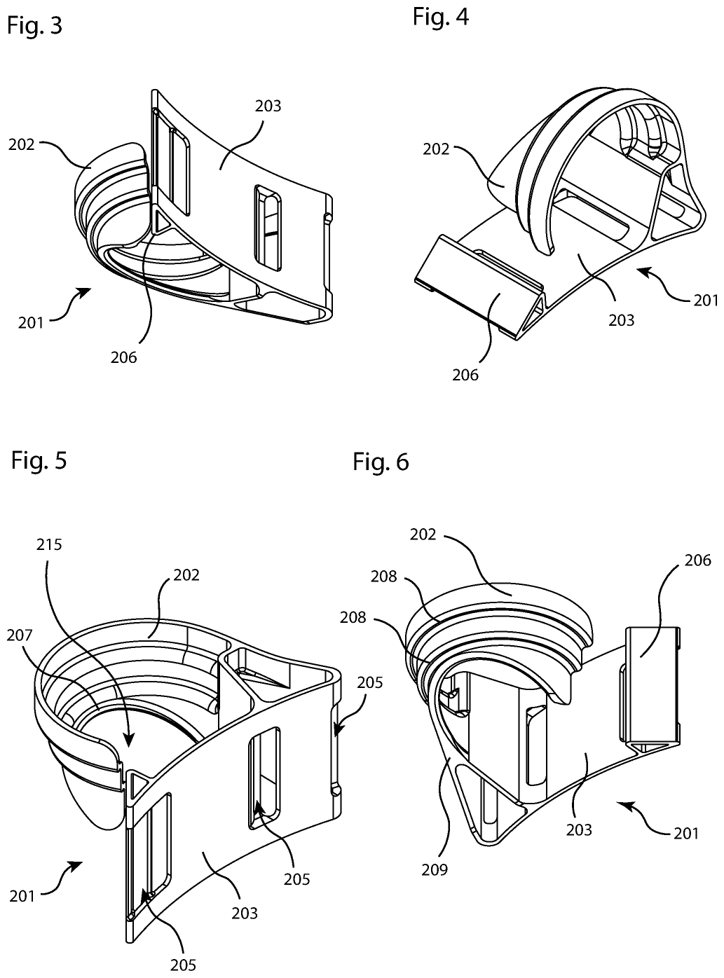

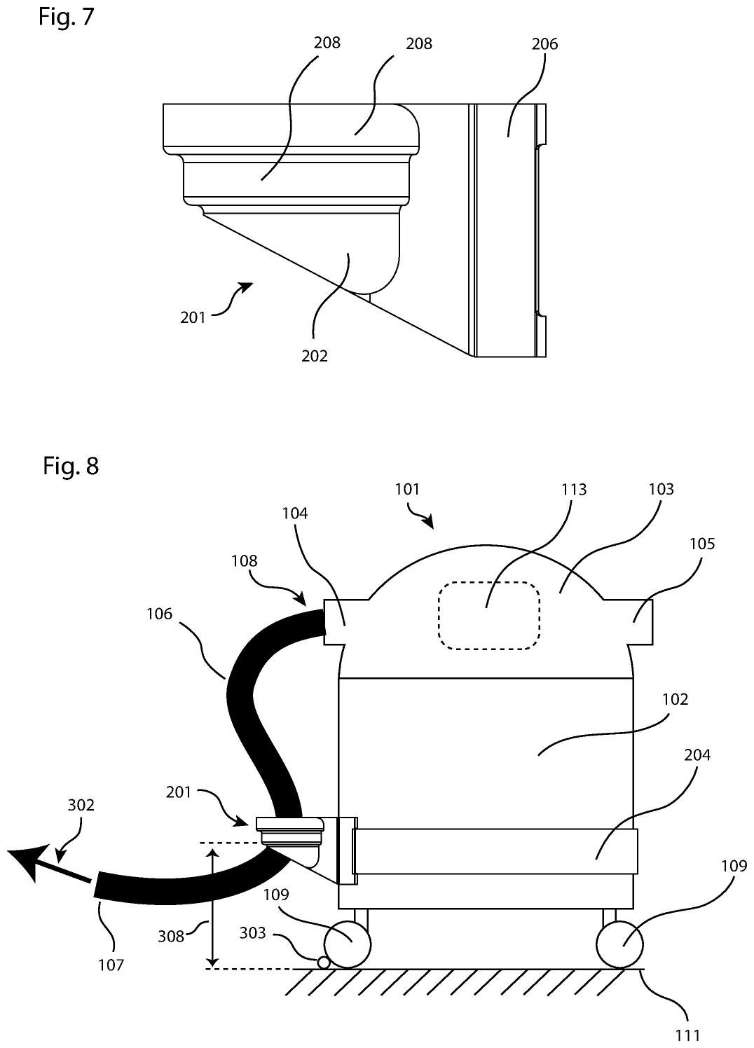

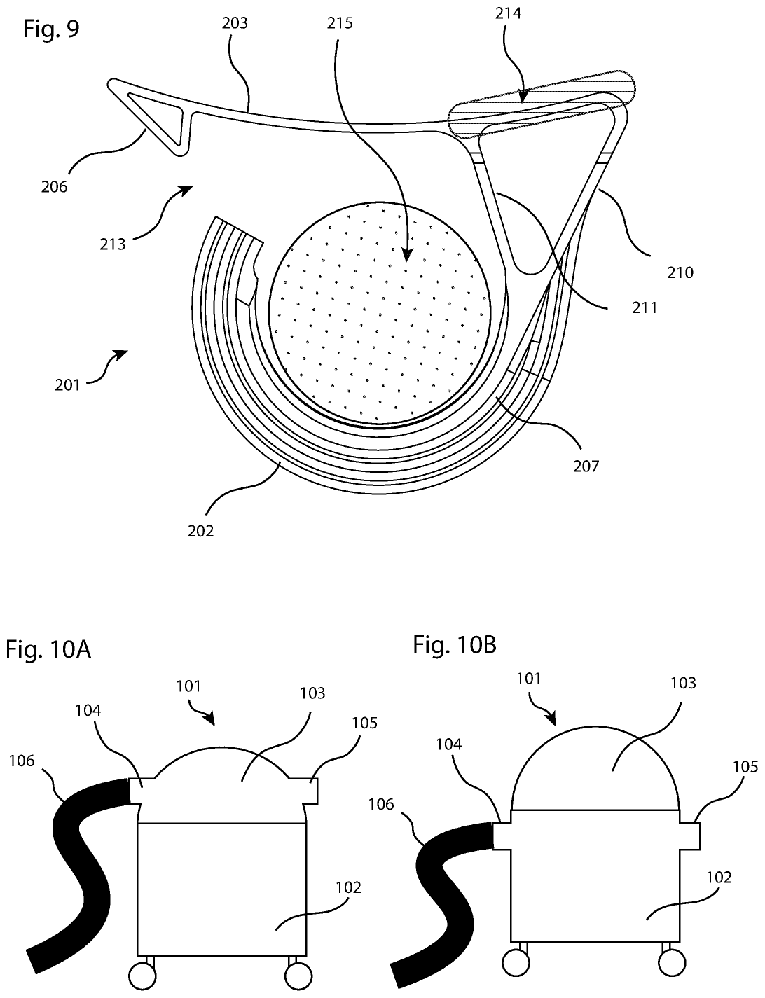

FIGS. 1-7 and 9 schematically illustrate various views of a stability bracket 201 that is usable to provide stability for, and generally prevent tipping of, wet/dry shop vacuums, which may generally be referred to as a vacuum cleaner assembly, vacuum assembly, or, simply, vacuum 101. The vacuum 101 typically consists of two major components, a lower housing 102 and an upper housing 103, as viewed in FIGS. 8 and 10-12.

The lower housing 102 is often a collection canister for debris collected by the vacuum 101 and is often shaped, generally, as a cylinder or similar to a cylinder. The upper housing 103 often includes a motor used to create pressure. There are typically two ports on the vacuum 101, a hose vacuum port 104 and a hose blower port 105. The user attaches a hose 106 to the respective port, depending on whether the user prefers the vacuum 101 to provide vacuum suction or blowing. The hose 106 includes a hose user side 107 and a hose attachment side 108, as schematically illustrated in FIG. 19.

The hose vacuum port 104 and the hose blower port 105 can be located on the upper housing 103, the lower housing 102, or combination thereof. For this application we will refer to the hose 106 being attached to the hose vacuum port 104, and it is understood that this is generally functionally the same as the hose 106 being attached to the hose blower port 105.

The vacuum 101 is generally cylindrical in nature. For reference, and without limitation, the lower housing 102 is typically 12-24 inches in diameter. For this application, the lower housing can be any shape with a perimeter of between, for example, and without limitation, roughly 36-84 inches.

The vacuum 101 is moved by rolling on a plurality of wheels 109 that are mounted on the bottom of the lower housing 102. The wheels typically consist of, for example, and without limitation, four casters spaced evenly around the lower housing 102. Note that alternative vacuums 101 may slide or roll without the use of the wheels 109—for example, and without limitation, tank-style treads or rolling or sliding balls—but the concepts and solutions described herein still apply to promote stability of the alternative vacuums 101.

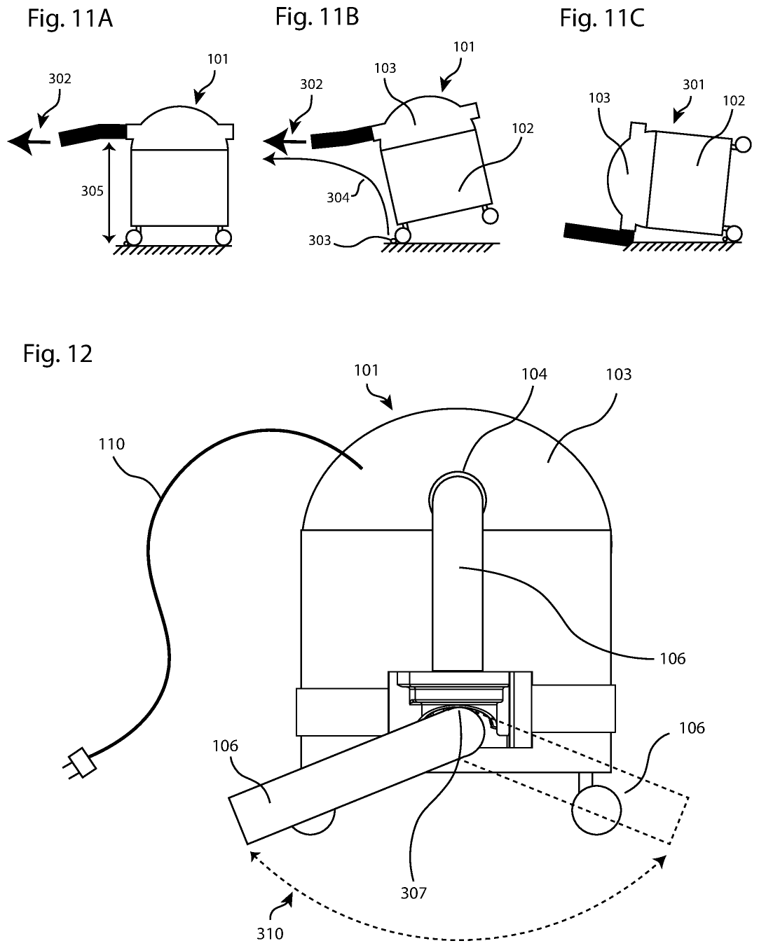

The wheels 109 will usually roll on a ground 111 and allow the vacuum 101 to move relative to the ground 111. However, if the wheels 109 are obstructed, the vacuum 101 loses stability and may tip over, illustrated schematically in FIGS. 11A-C. as tip 301. A power cord 110 is used to power a blower motor 113, which is often located in the upper housing 103. The blower motor 113 is often the heaviest part of the vacuum 101 and is mounting high on the vacuum 101, such that the vacuum 101 is prone to tipping.

While the present disclosure may be illustrated with respect to particular industries or applications, those skilled in the art will recognize the broader applicability of the products, methods, and techniques, described herein. For example, similar structures, methods, or combinations thereof, may be used in other industries than those described herein.

Those having ordinary skill in the art will also recognize that terms such as “above,” “below,” “upward,” “downward,” et cetera, are used descriptively of the figures, and do not represent limitations on the scope of the appended claims. Any numerical designations, such as “first” or “second” are illustrative only and are not intended to limit the scope of the claims in any way. Any use of the term, “or,” whether in the specification or claims, is inclusive of any specific element referenced and, also, includes any combination of the elements referenced, unless otherwise explicitly stated.

When used herein, the term “substantially” refers to relationships that are ideally perfect or complete, but where manufacturing realities prevent absolute perfection. Therefore, substantially denotes typical variance from perfection in the relevant art. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be within 5%.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting.

The vacuum 101 is prone to the tip 301 under certain circumstances, as schematically illustrated in FIGS. 11A-C. To move the vacuum 101, the user often pulls on the hose 106. This applied force is shown as a user force 302, which travels through the hose 106 to the hose vacuum port 104. The hose vacuum port 104 is often high up on the vacuum 101, as it is located on the upper housing 103 or an upper area of the lower housing 102.

Under normal circumstances, the vacuum 101 rolls as designed via the wheels 109. Problems occur when, for example, a wheel obstruction 303 occurs. The wheel obstructions 303 may be, for example and without limitation: a cord (including the power cord 110), pebble, or uneven concrete that prevents the wheel 109 from freely rolling on the ground 111.

Once the wheel 109 is bound by a wheel obstruction 303, tip 301 may often occur. Various wheel obstructions 303 are illustrated in FIGS. 16A, 16B, and 16C, including, for example and without limitation: including a cord (FIG. 16A), uneven pavement (FIG. 16B), and gravel or pebbles (FIG. 16C). A moment, shown as user moment 304, is created by the user force 302 rotating the vacuum 101 about a hose vacuum port height 305, which is substantially the distance of the hose vacuum port 104 to the ground 111.

The user force 302 is, therefore, applied at a very high level of the vacuum 101, well above the midpoint or half height of the vacuum 101. Preferably, the vacuum 101 would move over the wheel obstruction 303 but, more often than not, the user force 302 causes the vacuum 101 to tip 301 due the wheel obstruction 303.

Causing the vacuum 101 to tip 301 has negative consequences for the user, and may require additional work, such as to restore the vacuum 101 to its proper, upright, position. It is preferred for the vacuum 101 to roll over wheel obstructions 303, which is a benefit provided by attaching the stability bracket 201 to the lower housing 102 below the halfway height of the vacuum 101.

The stability bracket 201 was created to provide a single product solution to reduce the probability of tip 301 for various vacuum 101 shapes, sizes, and configurations. Therefore, as described herein, the stability bracket 201 is configured to mate to the shape and size of many different lower housings 102 of many different types of vacuums 101.

The stability bracket 201 generally consists of two primary components, a bracket hook or bracket arm 202, and a bracket mating feature, bracket mating arm, or, simply, mating arm 203. The bracket arm 202 is a feature designed to securely hold the hose 106 to the vacuum 101, and the mating arm 203 defines a mating surface configured to sit against, or abut, the vacuum 101. The bracket arm 202 is opposite the mating arm 203, which is configured to be attachable to the lower portions of the vacuum 101, generally on the lower housing 102.

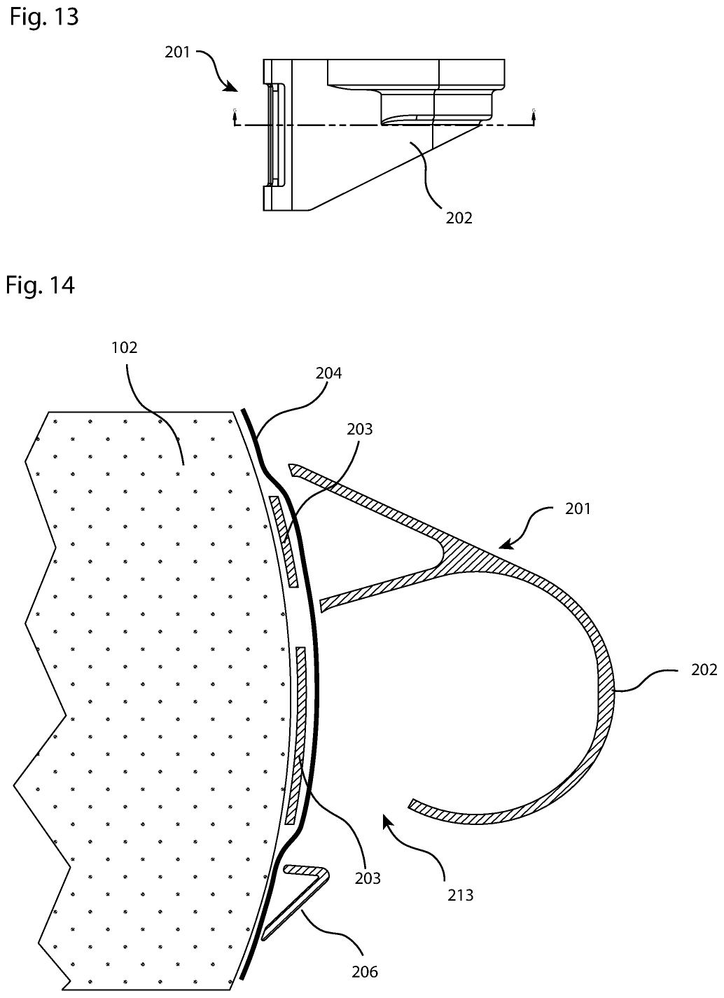

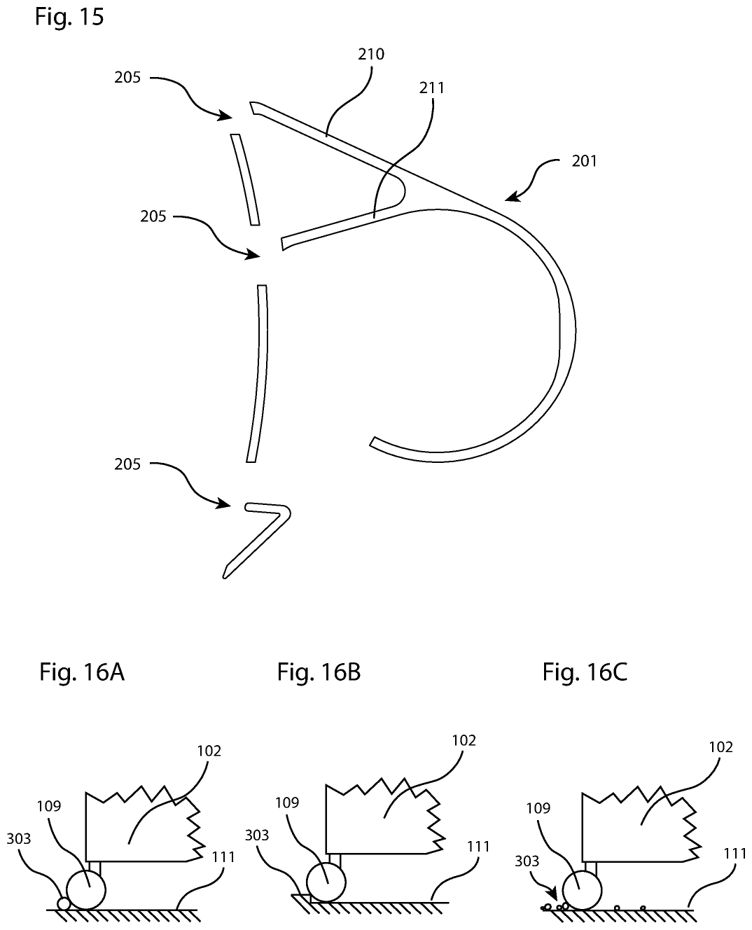

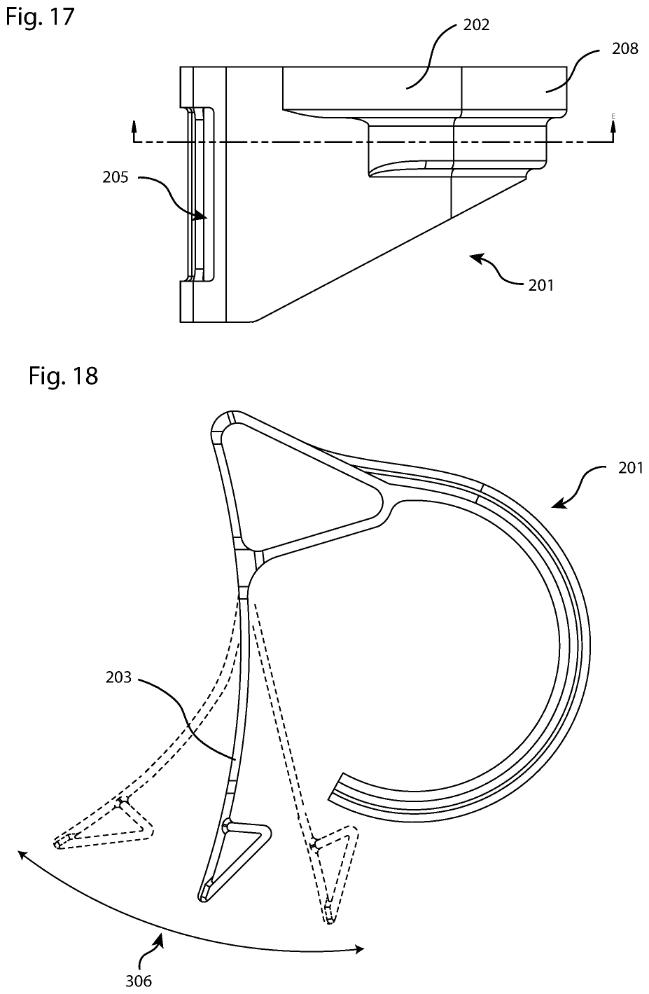

In the exemplary configuration shown, the stability bracket 201 is attached to the vacuum 101 by a strap 204. FIGS. 13-15 illustrate different views of the stability bracket 201 and the strap 204. There are one or more strap grooves 205 formed in the stability bracket 201, such that the strap 204 secures the mating arm 203 to the vacuum 101. The strap grooves 205 are shown schematically by lined areas in FIG. 15. The strap 204 is used to secure the stability bracket 201 to the bottom half of the vacuum 101, such that the user force 302 is applied to the bottom half of the vacuum 101.

One or more anti-slip mating surfaces for anti-slip features 212 may be applied to an interior or backside of the mating arm 203, which may assist in preventing the mating arm 203 from sliding on the lower housing 102 of the vacuum 101. The areas in which the anti-slip features 212 may be located are shown schematically in FIGS. 21 and 22. The anti-slip features 212 allow for the most versatile range of applications. In alternative applications, the bracket could be, for example and without limitation: molded into the lower housing 102; adhered or welded to the lower housing 102; or mated to the lower housing 102 via a snap-in or click-in interaction.

The hose 106 of the vacuum 101 is inserted into a gap between the bracket arm 202 and the mating arm 203, which may be referred to as a hose gap or hose installation gap 213. The bracket arm 202 is attached to the mating arm 203 on one side, at an arm attachment location 214. The space between the bracket arm 202 and the mating arm 203 may be referred to as a bracket hose space 215. The other side of the bracket arm 202 is open—i.e., not connected back to the mating arm 203—forming the hose installation gap 213.

The hose installation gap 213 allows the hose 106 to be easily inserted and removed from the bracket arm 202 while the stability bracket 201 is secured to the vacuum 101, such as with the strap 204. If both sides of the bracket arm 202 were attached to the mating arm 203, the entire hose 106 would need to be fed or threaded through the bracket hose space 215, substantially increasing the amount of time to insert and remove the hose. The flexibility of the bracket arm 202—due to single-sided attachment forming the hose installation gap 213—also allows for both smaller and larger diameter hoses 106, as the bracket arm 202 may flex outward away from the mating arm 203 and the lower housing 102.

When a user applies the user force 302 the load is applied to the stability bracket 201. The stability bracket 201 is mounted low—i.e., at or below the bottom half of the vacuum 101—on the lower housing 102. The height of the stability bracket 201 may be defined as a bracket height 308. The bracket height 308 is significantly lower than the hose vacuum port height 305, thus imparting a significantly reduced moment onto the vacuum 101. In some instances, the vector direction of the user force 302 is so significantly lowered that tip 301 when the wheels 109 are blocked by one or more wheel obstruction 303 becomes very unlikely.

The bracket arm 202 is attached to the mating arm 203 at the arm attachment location 214, and, to maximize strength two or more walls are used at the arm attachment location 214. In this configuration, two walls are used, a tangent bracket arm attachment 210 and a radial bracket arm attachment 211. The goal of these arm attachments is to spread any load from the bracket arm 202 onto the mating arm 203.

Note that the tangent bracket arm attachment 210 does not need to be perfectly tangential to the outer surface of the lower housing 102. Also, the radial bracket arm attachment 211 does not need to be perfectly radial to the diameter of the lower housing 102 of the vacuum 101. The arm attachment angles are designed with layout, cost, performance, and aesthetics in mind.

The bracket arm 202 has several features to improve performance. One is a hose locking feature 207, which is shown, for example, as one or more ribs formed on the interior of the bracket arm 202 and may be formed near a hose touch point 307. The hose 106 often includes serrations or ribs allowing for flexibility, shown as hose serrations 112. The hose locking feature 207 is designed to snap, slide, interlock, or otherwise interface with one or more of the hose serrations 112. The hose locking feature 207 prevents the hose 106 from sliding axially through the bracket hose space 215 defined by the bracket arm 202, and may also prevent causing a kink 309 at the hose vacuum port 104. Any kink 309 in the hose 106 generally reduces suction of the vacuum 101.

The user force 302 is focused or concentrated at the hose touch point 307 on the lower edge of the bracket arm 202, which is mounted to the lower half of the vacuum 101. This may cause the bracket arm 202 to flex or deform when subject to the user force 302. To maintain structural integrity, and minimize flexing of the bracket arm 202, one or more arm stiffeners 208 can be added to the bracket arm 202. Different stiffener options for the arm stiffeners 208 could include, without limitation: ribs, walls, steps, increased wall thickness, or other stiffening solutions recognizable to those having ordinary skill in the art.

FIG. 12 shows a front view of the stability bracket 201 installed on the vacuum 101, with the hose 106 inserted through the bracket hose space 215. If the user applies the user force 302 to the left or right the hose 106 could slide, which may change the hose touch point 307. This is not preferred because the hose 106 could unintentionally get pulled out of the hose installation gap 213. To remedy this solution a bracket arm bottom angle 209 was added, such that the upper edge of the bracket arm 202 is generally flat and the bottom edge of the bracket arm 202 is generally angled upward (as viewed in the figures) along the bracket arm bottom angle 209. This means that the hose 106 almost always has the same contact point, the sweeping, hose touch point 307 along the bracket arm bottom angle 209 in any direction of applied user force 302, allowing for a wide hose range of motion 310.

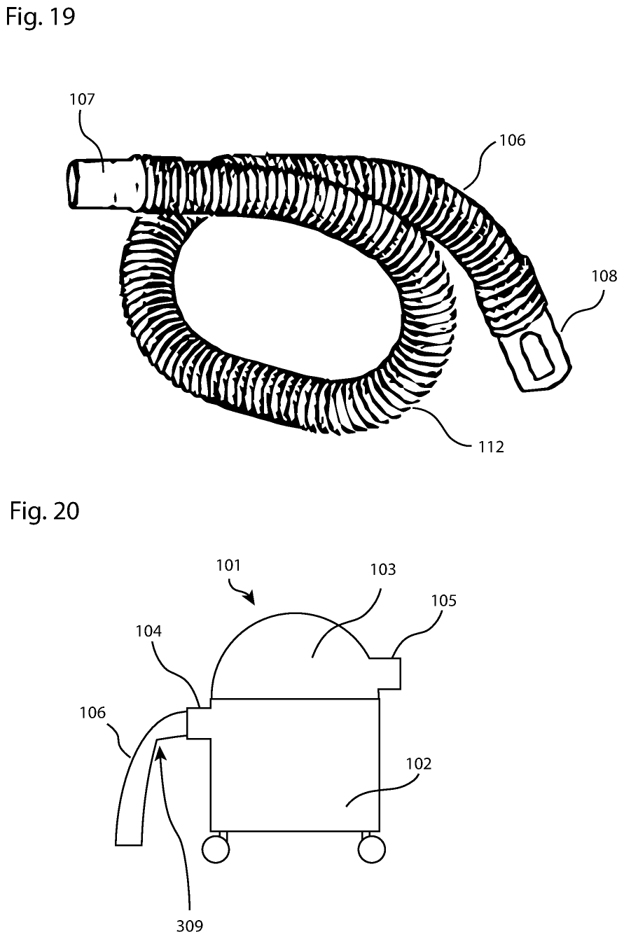

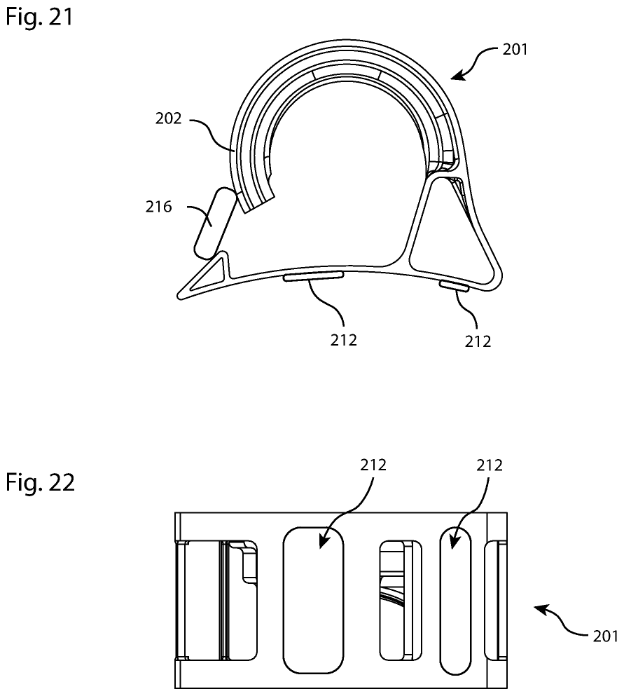

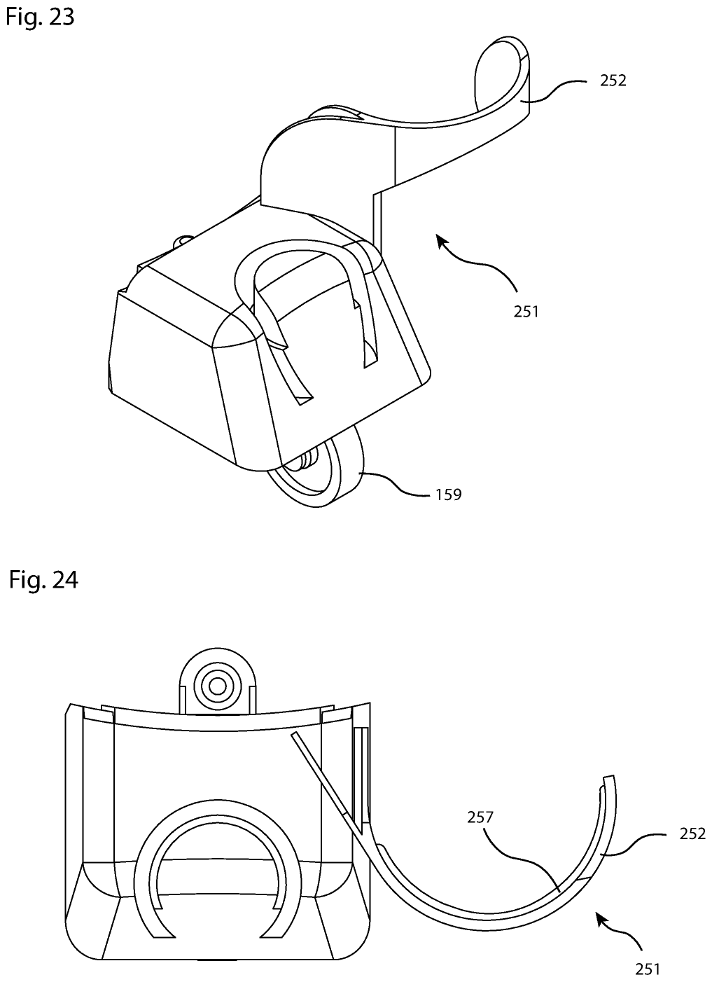

The mating arm 203 is designed to mate to various vacuum cleaner assemblies 101, irrespective of size and shape of the lower housing 102. To do this the mating arm 203 is designed with a bendable or flexible region, such that a bracket flex range or bracket flex zone 306 allows the stability bracket 201 to contour to the specific size and shape of the lower housing 102 of the specific vacuum 101 to which the stability bracket 201 is attached. Note that the bracket flex zone 306 is illustrated in FIG. 18, but the illustrated bracket flex zone 306 is highly exemplary and is not limiting.

The stability bracket 201 may also incorporate a mating surface hinge 217, which further tailers flexure of the bracket flex zone 306 along the mating arm 203. The mating surface hinge 217 may allow the bulk of the flexure to be focused to a specific region.

When the user applies the user force 302 to the stability bracket 201 at the hose touch point 307, it may create a moment on the mating arm 203, such as to the left or right, as viewed in FIG. 12. This could cause twisting of the stability bracket 201 about the mating arm 203. To prevent twisting, an anti-twist feature 206 was added to the stability bracket 201 generally adjacent to the hose installation gap 213. The anti-twist feature 206 provides structural support, or stiffening, opposite from the joint between the bracket arm 202 and the mating arm 203, and may be, for example and without limitation, ribs, walls, or other structure configured to prevent the hose 106 from twisting the mating arm 203 of the stability bracket 201.

Additional, optional, features may be included on the stability bracket 201. One or more anti-slip features 212 may be achieved via a rubber surface, rough surface, adhesives, or other high coefficient of friction surface treatments to minimize slipping between the back side of the mating arm 203.

An open arm closing feature 216 may be added to the stability bracket 201 to increase the strength of the bracket arm 202. This could include, for example, and without limitation, a metal or rubber latch, elastic band, or other feature that allows the bracket arm 202 to secure to the anti-twist feature 206 or another portion on the mating arm 203, in a manner that can easily be installed and uninstalled. Different mechanisms for the open arm closing feature 216 will be recognizable to those having ordinary skill in the art.

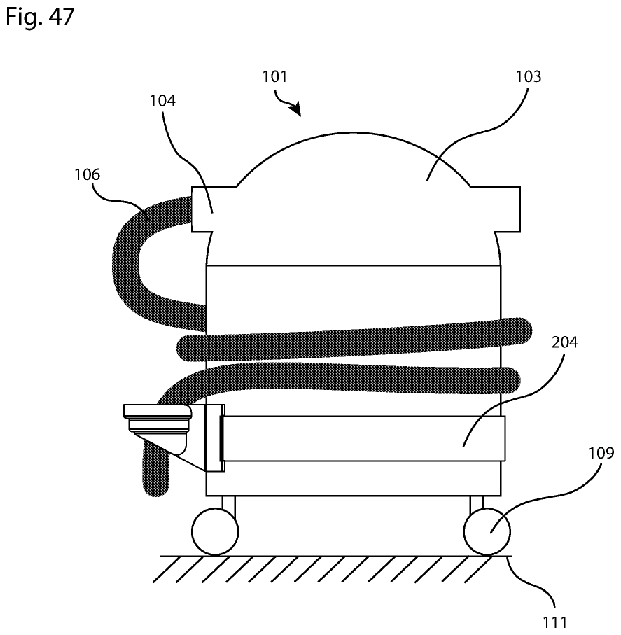

As an additional benefit of the stability bracket 201, the stability bracket 201 may also be used to assist in storage of the hose 106. As shown in FIG. 47, storage may occur by wrapping the hose 106 around the lower housing 102 and then placing the end of the hose 106 into the stability bracket 201.

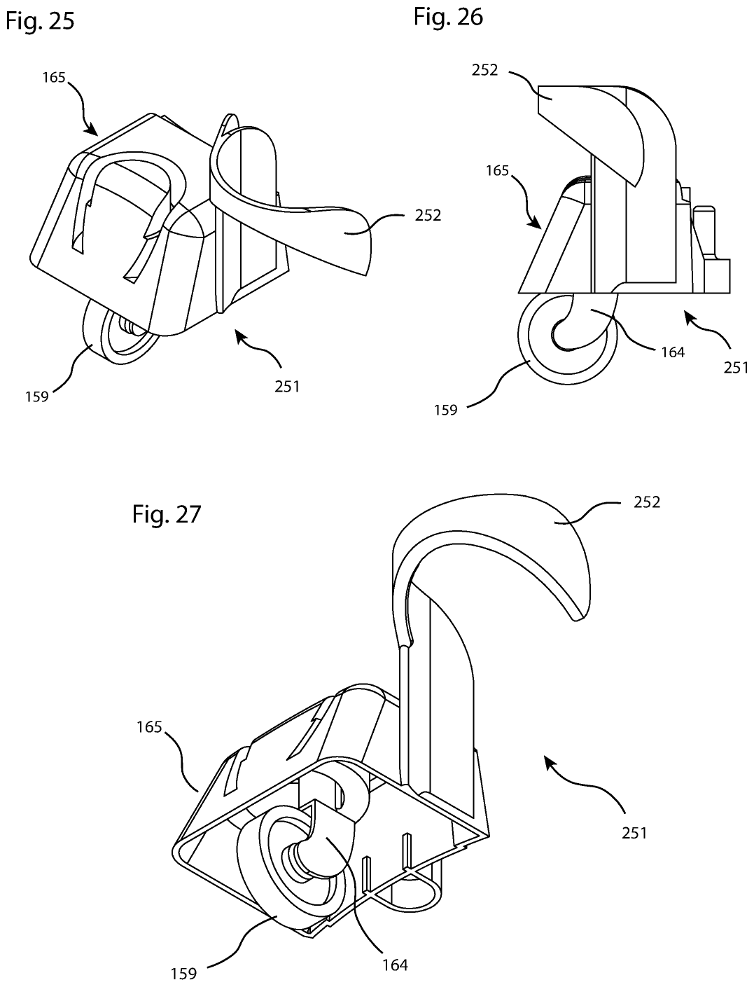

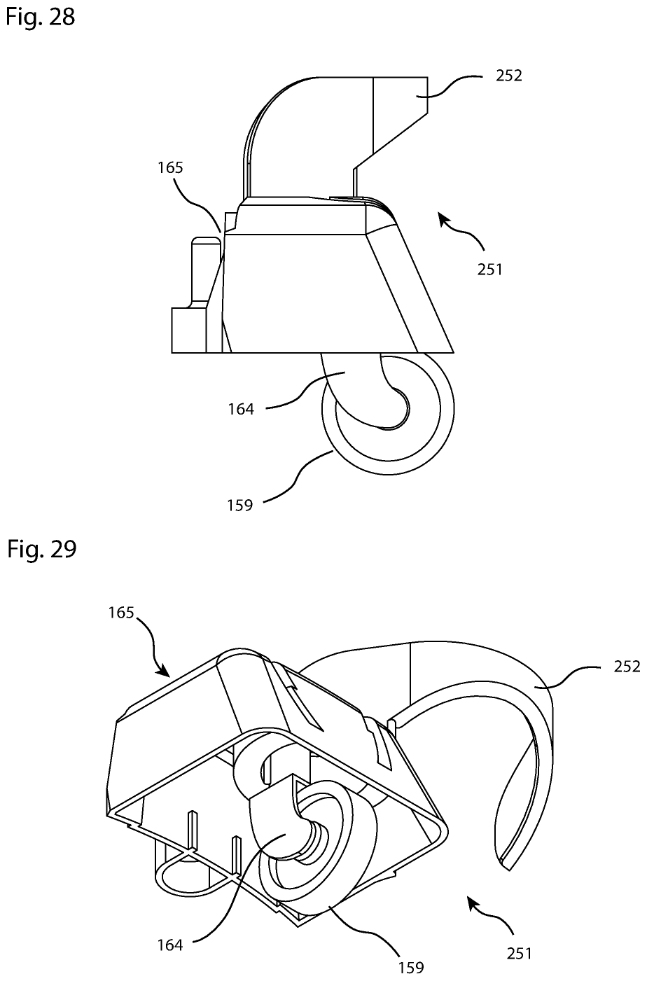

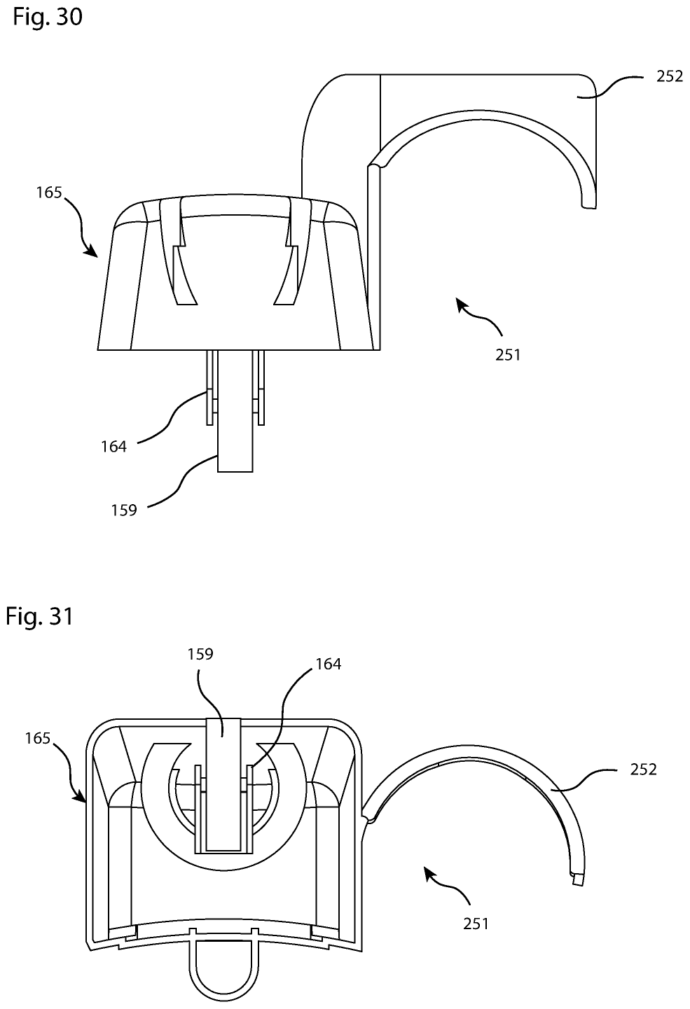

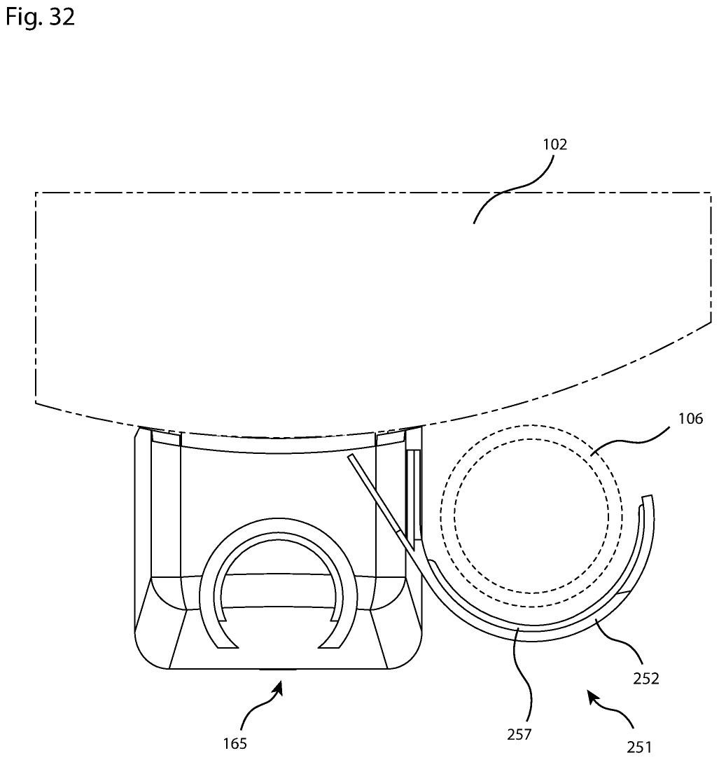

FIGS. 23-32, illustrate various views of an alternative configuration for a stability bracket, shown as a caster bracket 251. Often one or more wheels 159 are installed into a wheel caster 164. The wheel caster 164 is installed into a caster housing 165, which is typically, but not necessarily, molded from plastic and installed or attached to the lower housing 102 of the vacuum 101. Often manufacturing processes do not allow the caster housing 165 and the lower housing 102 to be the same part, so they may be assembled from multiple pieces.

As schematically illustrated in FIGS. 23-32, one way to reduce the user moment 304 is to form a caster bracket arm 252 directly with the caster housing 165. This may be advantageous as an OEM application for the manufacturer of the vacuum 101, because it doesn't require additional pieces for assembly of the lower housing 102. The caster bracket arm 252 may also have a hose locking feature 257 formed thereon, in addition to any of the other features referenced relative to the stability bracket 201.

In some configurations, the caster bracket arm 252 may be integrally formed with the caster housing 165. As used relative to the caster bracket arm 252, the term integrally refers to structures that are continuous and do not require subsequent attachment, such as, for example and without limitation, forming the caster bracket arm 252 and the caster housing 165 by molding both components together from plastic or other suitable materials.

One wheel caster housing may be replaced with the caster bracket 251 having the caster bracket arm 252 integrated thereto. This performs a similar function as the stability bracket 201, but would not be universal in nature—i.e., would not be attachable to a wide range of vacuums 101—and would be less removable, switchable, and reusable, relative to the stability bracket 201 attached via the strap 204.

As an alternative to either the stability bracket 201 or the caster bracket 251, a similar bracket arm may be formed, or added, to the lower housing 102. Note, however, that this requires additional cost and design effort by the manufacturer of the vacuum 101. At best, the lower housing 102 would require a molded in slot or mating element to attach the alterative bracket arm, which requires a complete redesign of at least the lower housing 102.

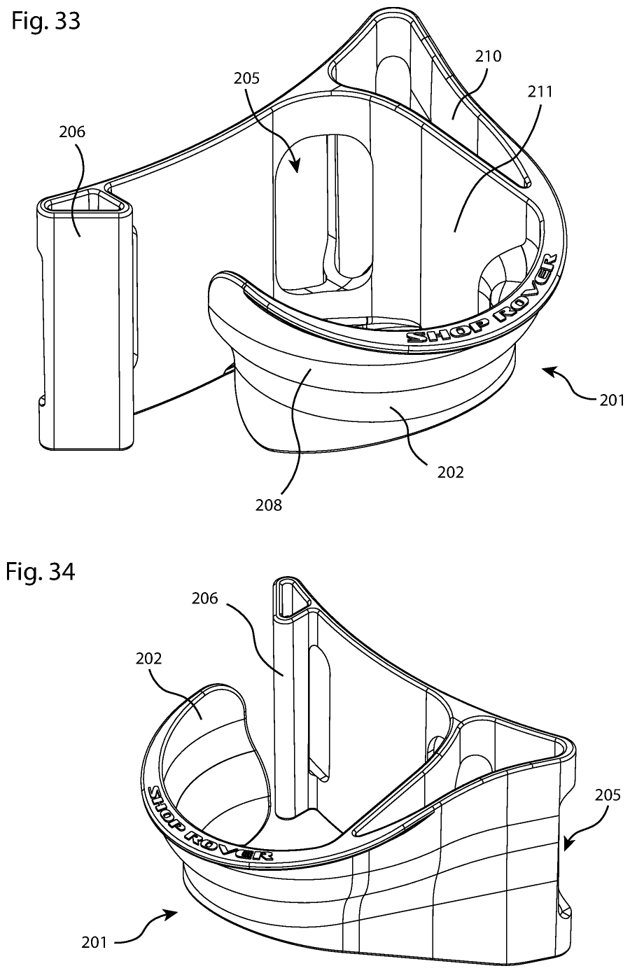

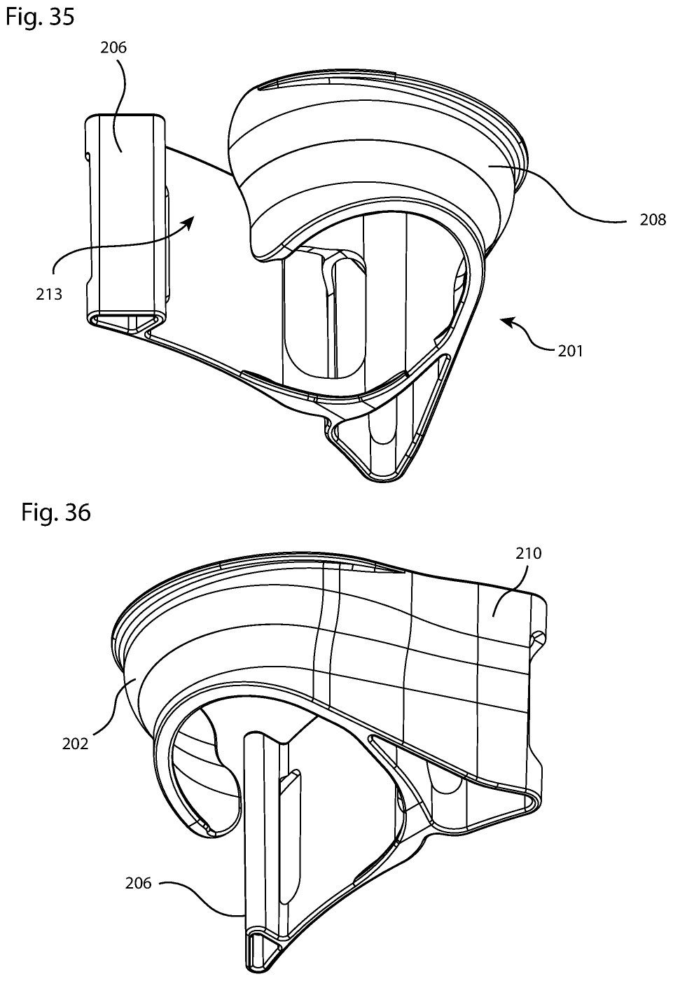

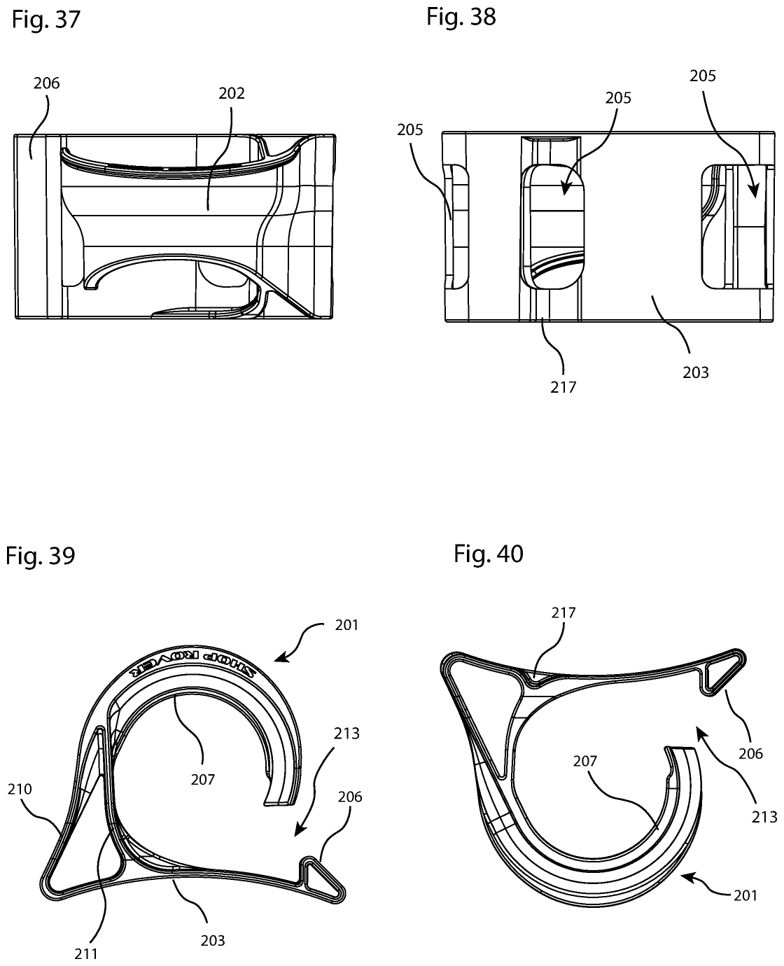

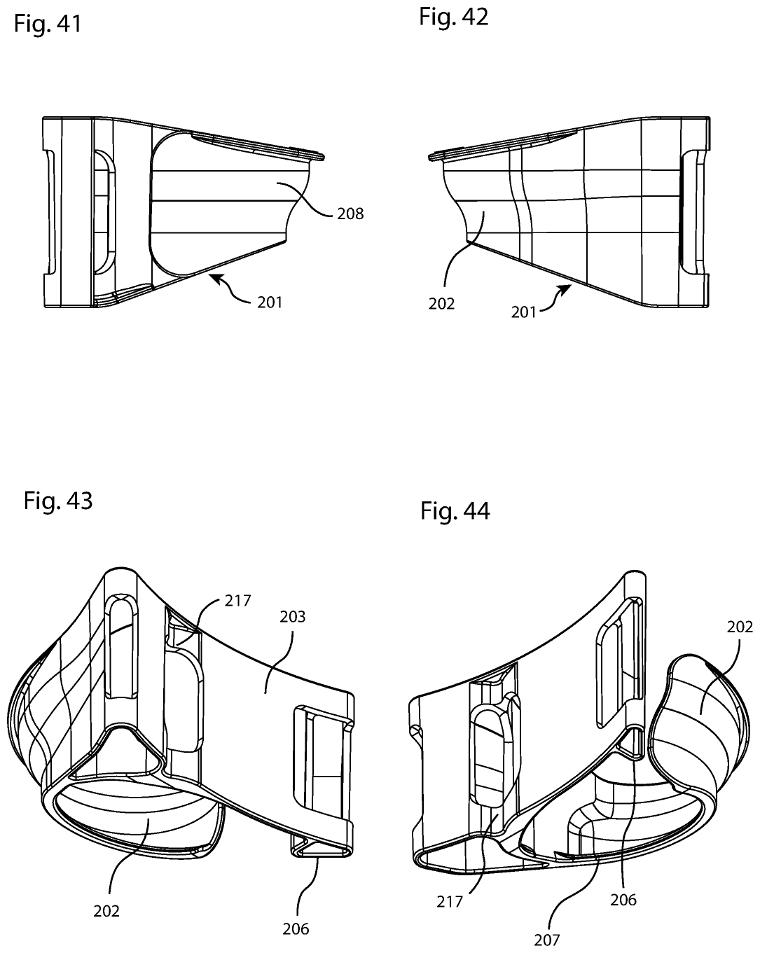

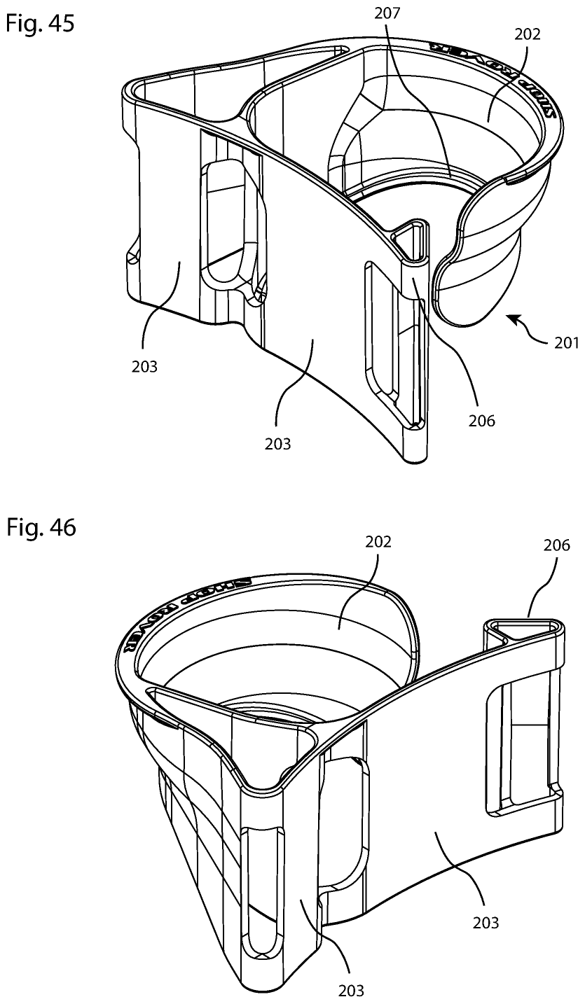

FIGS. 33-46 schematically illustrate views of an optimized version of the stability bracket 201. The optimized version has similar, often nearly identical features, to those shown in the previous views of the stability bracket 201. The optimized stability bracket 201 includes improvements for manufacturing and aesthetic purposes, such that the feature numbers are unchanged, as they relate to operation and function in the same way.

The detailed description and the drawings or figures are supportive and descriptive of the disclosure. While some of the best modes and other embodiments for carrying out the disclosure have been described in detail, various alternative designs, configurations, and embodiments exist for practicing the appended claims, as will be recognized by those having ordinary skill in the art.

Furthermore, any embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A stability bracket, comprising:
a mating arm defining a flexible region, such that the mating arm is configured to conform to different sized shapes; and
a bracket arm operatively attached to one side of the mating arm, and defining a hose gap opposite the attachment to the mating arm.

2. The stability bracket of claim 1,
wherein the bracket arm has a flat upper surface and an angled lower surface.

3. The stability bracket of claim 2, further comprising:
one or more ribs formed on an interior of the bracket arm.

4. The stability bracket of claim 3, further comprising:
an anti-slip feature attached to an interior of the mating arm.

5. The stability bracket of claim 4, further comprising:
an anti-twist feature formed on the mating arm adjacent the hose gap.

6. The stability bracket of claim 1, further comprising:
one or more ribs formed on an interior of the bracket arm.

7. The stability bracket of claim 6, further comprising:
an anti-twist feature formed on the mating arm adjacent the hose gap.

8. A stability bracket configured to be attached to a vacuum having a hose, comprising:
a mating arm defining a flexible region, such that the mating arm is configured to conform to the vacuum, irrespective of size; and
a bracket arm operatively attached to one side of the mating arm, and defining a hose gap opposite the attachment side, wherein the hose gap is configured to receive the hose.

9. The stability bracket configured to be attached to the vacuum of claim 8,
wherein the bracket arm has a flat upper surface and an angled lower surface, such that the hose has one point of contact with the bracket arm.

10. The stability bracket configured to be attached to the vacuum of claim 9,
wherein the stability bracket is attached to the vacuum via a strap, such that the stability bracket is attached at or below a bottom half of the vacuum, and
wherein pulling on the hose applies a pull force to the bottom half of the vacuum.

11. The stability bracket configured to be attached to the vacuum of claim 10, further comprising:
one or more ribs formed on an interior of the bracket arm, wherein the ribs are configured to interlock with the hose and to prevent the hose from sliding within the bracket arm.

12. The stability bracket configured to be attached to the vacuum of claim 11, further comprising:
an anti-slip feature attached to the interior of the mating arm, such that the anti-slip feature contacts the vacuum.

13. The stability bracket configured to be attached to the vacuum of claim 8, further comprising:
one or more ribs formed on an interior of the bracket arm, wherein the ribs are configured to interlock with the hose and to prevent the hose from sliding within the bracket arm.

14. A vacuum cleaner assembly having a hose, comprising:
an upper housing;
a lower housing;
a wheel caster housing operatively attached to the lower housing;
a wheel rotatably attached to the wheel caster housing; and
a caster bracket arm extending from the wheel caster housing, wherein the hose is configured to sit within the caster bracket arm.

15. The vacuum cleaner assembly of claim 14, wherein the caster bracket arm is integrally formed with the wheel caster housing.

16. The vacuum cleaner assembly of claim 15, further comprising:
a blower motor within the upper housing, such that the hose is configured to pull on the caster bracket arm on an opposite side of the lower housing from the blower motor.
